(19) United States
(12) Patent Application Publication
(10) Pub. No.: US 2007/0041217 A1
(43) Pub. Date: Feb. 22, 2007

(54) Mold frame capable of enhancing luminance in a light assembly

(76) Inventors: Yong-II Kim, Gyeonggi-do (KR); Jae-Min Choi, Chungcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/504,375

(22) Filed: Aug. 14, 2006

(30) Foreign Application Priority Data
Aug. 16, 2005 (KR) 2005-74650
Sep. 26, 2005 (KR) 2005-89122

(51) Int. Cl. F21V 7/04

(52) U.S. Cl. 362/633

(57) ABSTRACT

A mold frame that is useful for enhancing the luminance and reducing leakage current in a display device or a backlight assembly is presented. The mold frame includes a first face and a second face. The mold frame covers the ends of each of a plurality of lamps and supports an optical member placed on the lamps. The first face supports the optical member. The second face, which extends from the first face, includes a lamp-inserting portion into which the ends of the lamps are inserted, and a lamp-fixing member arranged in each of the lamp-inserting portions to support the lamps. With the invention, straight portions of a U-shaped CCFL are arranged substantially parallel to each other so that leakage current is reduced. Formation of a temperature gradient within a lamp is reduced or suppressed.

### CROSS-REFERENCE TO RELATED APPLICATIONS

This application claims priority under 35 USC § 119 to Korean Patent Application No. 2005-74650 filed on Aug. 16, 2005 and Korean Patent Application No. 2005-89122 filed on Sep. 26, 2005, the contents of which are herein incorporated by reference in their entireties for all purposes.

### BACKGROUND OF THE INVENTION

1. Field of the Invention

The present invention relates to a mold frame, a backlight assembly having the mold frame and a display device having the backlight assembly. More particularly, the present invention relates to a mold frame having a lamp-fixing structure, a backlight assembly having the mold frame and a display device having the backlight assembly.

2. Description of the Related Art

In general, a display device is an apparatus that processes information (e.g., electrical signals) and presents the information in a form that is recognizable by users (e.g., images). A flat type display device, which is a type of display device that is known to be lightweight and high-resolution, has been widely used.

Of the different types of flat type display devices, liquid crystal display (LCD) device is becoming increasingly prevalent. An LCD device displays an image using a layer of liquid crystal (LC) molecules. Light transmittance through the LC layer varies in accordance with the intensity of an electric field in the LC layer.

LCD device is classified into transmissive type, reflective type, and reflective-transmissitve type. A transmissive-type LCD device displays an image using light provided from an artificial light source such as a backlight assembly. A reflective-type LCD device displays an image using natural or ambient light. A reflective-transmissive type LCD device displays an image using artificial light and natural/ambient light.

The transmissive LCD device typically uses a backlight assembly positioned behind a display panel as the light source. The backlight assembly is classified into a direct-illumination type backlight assembly and an edge-type backlight assembly in accordance with the positions of the light source.

The direct-illumination type backlight assembly includes a plurality of light sources arranged under the display panel. The edge-type backlight assembly includes a light source arranged at a side of a light-guiding plate.

A tubular cold cathode fluorescent lamp (CCFL) is commonly used as the light source in the direct-illumination type backlight assembly. A plurality of the tubular CCFLs is arranged under the display panel to supply high-luminance light to the display panel.

Since a direct-illumination type backlight assembly uses multiple tubular CCFLs, the cost for manufacturing the backlight assembly is increased. Further, fixing members such as a holder for assembling the tubular CCFLs with the backlight assembly are provided at both ends of the tubular CCFLs, further raising the cost for manufacturing the backlight assembly.

To overcome the above-mentioned problems, the direct illumination type backlight assembly using a U-shaped CCFL as the light source has been suggested as an alternative.

In a structure using the U-shaped CCFL as the light source, fewer number of CCFLs is used compared to a structure using tubular CCFLs. Thus, with U-shaped CCFLs, backlight assemblies that achieve a luminance substantially the same as that of a backlight assembly having tubular CCFLs is manufactured by using fewer number of CCFLs. As a result, in the backlight assembly having U-shaped CCFLs, manufacturing cost is controlled by the decreased numbers of the CCFLs and the fixing members.

In the structure using the U-shaped CCFL as the light source, a lamp-fixing member is attached to a bent portion of the U-shaped CCFL to support the U-shaped CCFL. The lamp-fixing member causes a problem by functioning as a heat-transferring member. Thus, the lamp-fixing member dissipates heat generated in the bent portion to cool the bent portion. As the temperature of the bent portion drops, a temperature gradient occurs in the U-shaped CCFL. The temperature gradient in the U-shaped CCFL causes mercury flow in the U-shaped CCFL.

As the mercury flows in the U-shaped CCFL mercury concentration becomes lower in some regions of the U-shaped CCFL than in other regions. Light emitted from the less concentrated region has a lower luminance than light emitted from other regions. As a result, the overall luminance level of light emitted from the backlight assembly is lowered and the backlight assembly has a reduced light efficiency.

### SUMMARY OF THE INVENTION

In one aspect, the invention is a mold frame covering ends of a plurality of lamps and supporting an optical member. The mold frame includes a first face and a second face extending from the first face. The first face supports the optical member. The second face includes lamp-inserting portions into which the ends of the lamps are inserted and a lamp-fixing member arranged in the inserting portion to support the lamps.

In another aspect, the invention is a mold frame covering ends of a plurality of lamps and supporting an optical member that is arranged on the lamps. The mold frame includes a first face and a second face. The first face supports an optical member. The second face, which extends from the first face, includes a lamp-inserting portion into which the ends of the lamps are inserted, and lamp-fixing members arranged in the lamp-inserting portion to support the lamps. At least one of the lamp-fixing members has a curved portion and a straight portion and the straight portion contacts one of the lamps.

In another aspect, the invention is a backlight assembly that includes lamps, optical members and a mold frame. The lamps emit light. The optical members are arranged over the lamps to improve luminance characteristics of the light. The mold frame covers the ends of the lamps. The mold frame includes lamp-inserting portions into which the ends of the lamps are inserted, respectively, and lamp-fixing members arranged in each of the inserting portions to support the lamps.

A display device in accordance with one aspect of the present invention includes lamps, optical members, a mold frame and a display panel. The lamps emit light. The optical members are arranged on the lamps to improve luminance characteristics of the light. The mold frame covers ends of each lamp. The mold frame includes lamp-inserting portions into which the ends of the lamps are inserted, and lamp-fixing members arranged in the inserting portions to support the lamps. The display panel is arranged on the optical members to display an image using the light that passes through the optical members.

In yet another aspect, the invention is a backlight assembly including lamps, optical members, and a mold frame. The lamps emit light, and the optical members are arranged on the lamps to improve luminance characteristics of the light. The mold frame, which covers the ends of the lamps, includes lamp-inserting portions and a lamp-fixing member arranged in each of the lamp-inserting portions. Ends of the lamps are inserted into the lamp-inserting portions. Each lamp-fixing member supports one of the lamps and has a straight portion that makes contact with the lamp being supported.

In yet another aspect, the invention is a display device that includes lamps, optical members, a mold frame and a display panel. The lamps emit light. The optical members are arranged over the lamps to improve luminance characteristics of the light. The mold frame, which covers the ends of the lamps, includes lamp-inserting portions into which the ends of the lamps are inserted and lamp-fixing members arranged in each of the inserting portions to support the lamps. The lamp-fixing members have at least one straight portion that contacts one of the lamps. The display panel is arranged over the optical members to display an image using the light that passes through the optical members.

The present invention allows the straight portions of a U-shaped CCFL to be arranged substantially parallel to each other, thereby reducing leakage current. Further, the lamp-fixing members for fixing the U-shaped CCFL may prevent a temperature gradient from forming within the lamp and adversely affecting the luminance of any device employing the lamp

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a perspective view illustrating a mold frame in accordance with one embodiment of the present invention;

FIG. 2 is an enlarged front view of a portion “A” in FIG. 1;

FIG. 3 is a perspective view illustrating a lamp fixed to a lamp-fixing member;

FIG. 4 is a perspective view illustrating a mold frame in accordance with one embodiment of the present invention;

FIG. 5 is an enlarged front view of a portion “B” in FIG. 4;

FIG. 6 is a front view illustrating configurations of a lamp-fixing member with which the lamp is assembled in accordance with one embodiment of the present invention;

FIG. 7 is a side view illustrating the lamp-fixing member in FIG. 6;

FIG. 8 is an exploded perspective view illustrating a backlight assembly in accordance with one embodiment of the present invention;

FIG. 9 is an exploded perspective view illustrating a display device in accordance with one embodiment of the present invention;

FIG. 10 is a perspective view illustrating a lamp-fixing member in accordance with Comparative Example 1;

FIG. 11 is a cross-sectional view illustrating a backlight assembly having the lamp-fixing member in FIG. 10;

FIG. 12 is a perspective view illustrating a lamp-fixing member in accordance with Comparative Example 2;

FIG. 13 is a front view illustrating a lamp on which temperature measurement points are indicated;

FIG. 14 is a graph illustrating temperature differences between the lamp-fixing members in FIGS. 10 and 12;

FIG. 15 is a front view illustrating a lamp fixed to the lamp-fixing member in FIG. 12;

FIG. 16 is a perspective view illustrating a mold frame in accordance with one embodiment of the present invention;

FIG. 17A is an enlarged front view of a portion “C” in FIG. 16;

FIG. 17B is an enlarged front view of a portion “C” in FIG. 16 in accordance with one embodiment of the present invention;

FIG. 18 is a front view illustrating configurations of a lamp-fixing member with which the lamp is assembled in accordance with one embodiment of the present invention;

FIG. 19 is a side view illustrating the lamp-fixing member in FIG. 18;

FIG. 20 is an exploded perspective view illustrating a backlight assembly in accordance with one embodiment of the present invention; and

FIG. 21 is an exploded perspective view illustrating a display device in accordance with one embodiment of the present invention.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

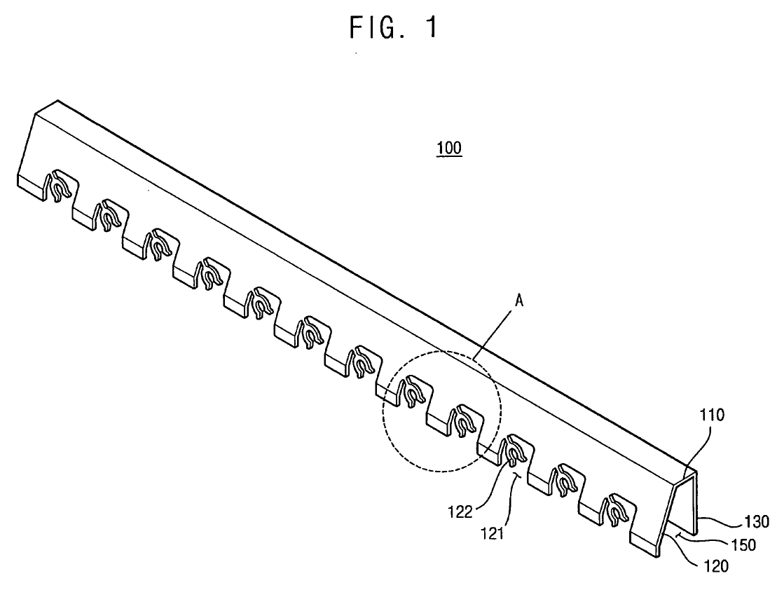

FIG. 1 is a perspective view illustrating a mold frame in accordance with one embodiment of the present invention.

Referring to FIG. 1, a mold frame 100 includes a first face 110 for supporting optical members (not shown), and a second face 120 extending from one end of the first face 110 to fix lamps (not shown). The mold frame 100 may further include a third face 130 extending from another end of the first face 110.

The mold frame 100 supports optical members. Further, the mold frame 100 covers dark fields, which may be formed at an end of each lamp, to improve luminance characteristics of a backlight assembly in which the mold frame 100 is employed.

When the mold frame 100 includes the third face 130, the third face 130 makes contact with an inner wall of a container (not shown) in which the mold frame 100 is received to support the mold frame 100. Further, the third face 130 provides the lamps and the optical members with a gap. In this embodiment, the third face 130 is arranged in a plane that is substantially perpendicular to a bottom face of the container and substantially parallel to the inner wall of the container.

The first face 110 is formed between first edges of the first and third faces 110 and 130 to support the optical members. The first face 110 may lie in a plane that is substantially perpendicular to the third face 130. Thus, the first face 110 is substantially parallel to the bottom face of the container to support the optical members.

The second face 120 extends from the first face 110. The end of each lamp is received in a space 150 defined by the first to third faces 110, 120 and 130 so that the dark field, which may be formed at the end of each lamp, is covered with the mold frame 100.

The second face 120 may be inclined with respect to the first face 110. The incline is designed to upwardly reflect the light emitted from the lamps to improve luminance characteristics of the backlight assembly. In some embodiments, a light-reflecting member (not shown) may be formed on the inclined face to further improve the luminance characteristics of the backlight assembly.

The second face 120 has lamp-inserting portions 121 into which the end of each lamp is inserted. The end of each lamp inserted into the lamp-inserting portions 121 is positioned in the space 150 defined by the first to third faces 110, 120 and 130. Lamp-fixing members 122 are arranged in the lamp-fixing portions 121, respectively.

Hereinafter, lamp-fixing members in accordance with Comparative Examples are illustrated in detail with reference to accompanying drawings.

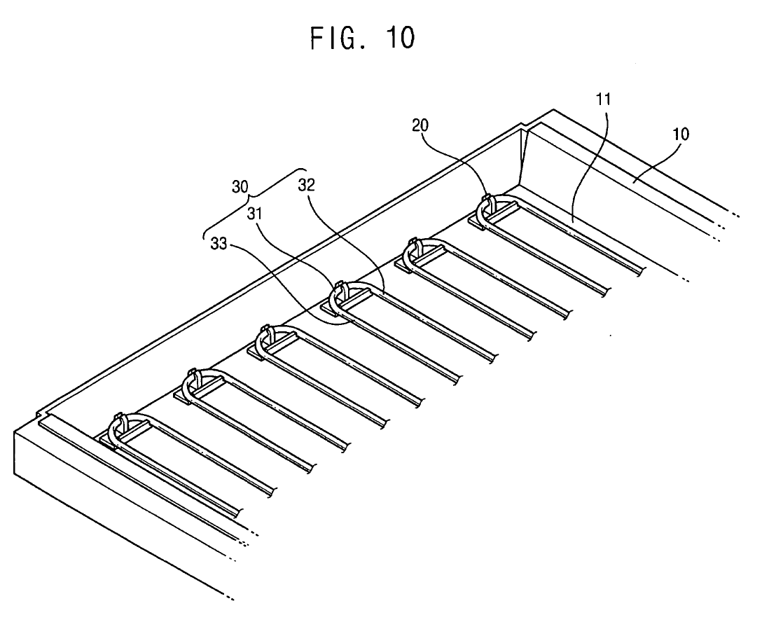

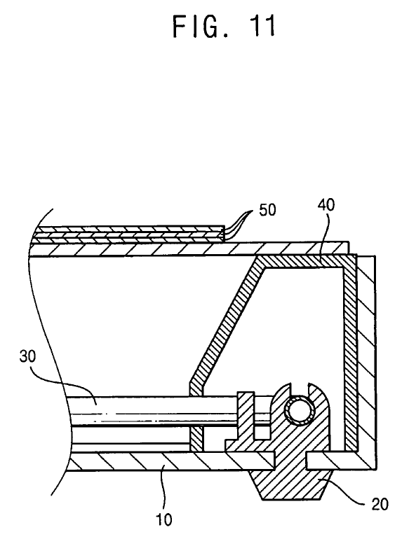

FIG. 10 is a perspective view illustrating a lamp-fixing member in accordance with another embodiment of the present invention and FIG. 11 is a cross-sectional view illustrating a backlight assembly having the lamp-fixing member in FIG. 10.

Referring to FIGS. 10 and 11, a lamp-fixing member 20 penetrates a container 10 in which a lamp 30, a mold frame 40 and an optical member 50 are received. The lamp-fixing member 20 is combined with the container 10. In this example, the lamp 30 is a U-shaped CCFL.

The lamp-fixing member 20 has a holder type configuration. The lamp-fixing member 20 hooks up a bent portion 31 of the lamp 30 to provide the lamp 30 with a space from a bottom face 11 of the container 10. Further, the lamp-fixing member 20 allows a first straight portion 32 and a second straight portion 33 of the lamp 30, which extend from both ends of the bent portion 31, to lie on the bottom face 11.

Here, the lamp-fixing member 20 in FIGS. 10 and 11 serves as a heat conductor so that heat generated in the bent portion 31 is dissipated outside of the container 10.

Accordingly, a temperature of the bent portion 31 is decreased so that a temperature gradient is generated in the lamp 30. As mentioned above, the temperature gradient causes mercury (Hg) to flow in the lamp 30. The mercury flow results in non-uniform luminance of the lamp 30 by decreasing the luminance of light that is emitted from a region in the lamp 30 having a relatively low mercury concentration. As a result, efficient luminance characteristics of a backlight assembly having the lamp-fixing member 20 may be less than that of the backlight assembly having the lamp fixing member shown in FIGS. 1 to 9.

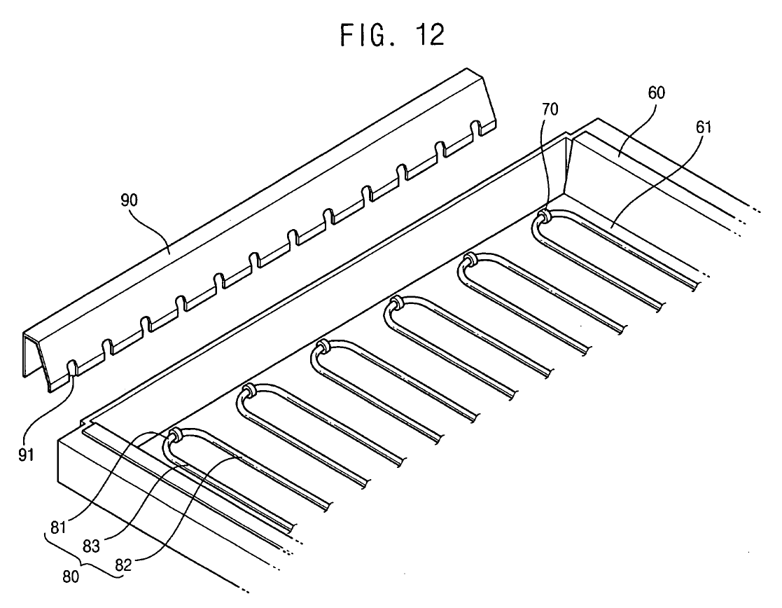

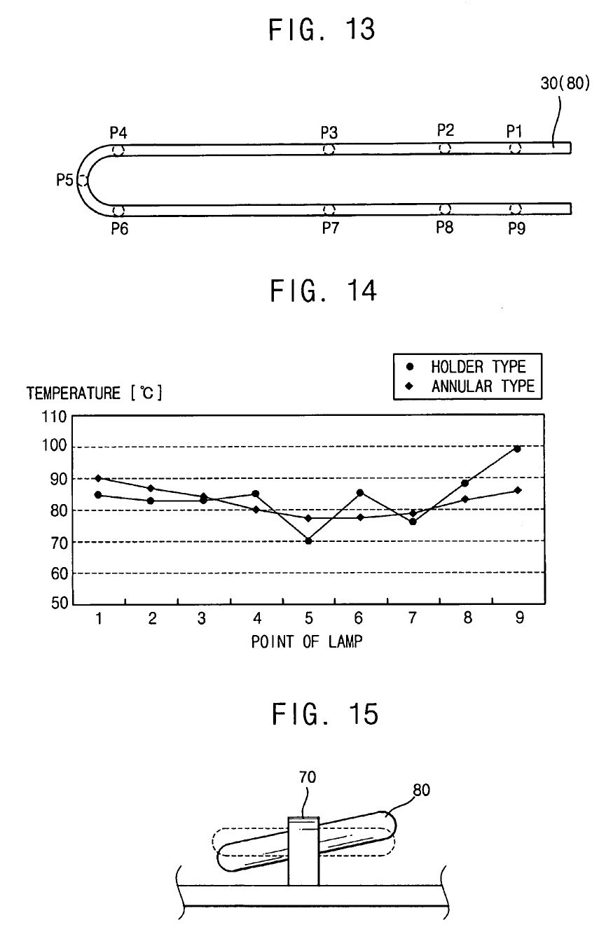

FIG. 12 is a perspective view illustrating a lamp-fixing member in accordance with Comparative Example 2, FIG. 13 is a front view illustrating a lamp on which temperature measurement points are indicated, FIG. 14 is a graph illustrating temperature differences between the lamp-fixing members in FIGS. 10 and 12 and FIG. 15 is a front view illustrating a lamp fixed to the lamp-fixing member in FIG. 12.

Referring to FIG. 12, an annular lamp-fixing member 70 is used to prevent the temperature gradient from forming within the lamp 80.

The lamp-fixing member 70 fixes a bent portion 81 of a U-shaped lamp 80. The lamp-fixing member 80 supports the bent portion 81 of the lamp 80 for allowing a first straight portion 82 and a second straight portion 83 of the lamp 80, which extend from the bent portion 81, to be positioned on a bottom face 61 of a container 60.

The lamp 80 whose bent portion 81 is fixed to the lamp-fixing member 70 is received in the container 60. The lamp 80 is inserted into a lamp-insertion portion 91 of a mold frame 90 so that the mold frame 90 covers the bent portion 81 of the lamp 80 fixed to the lamp-fixing member 70.

As will be explained below, the annular lamp-fixing member 70 solves the temperature gradient problem described above.

FIG. 13 shows various points P1 to P9 on the lamps 30/80. FIG. 14 shows the temperatures measurements at points P1 to P9 on the lamps 30/80. As shown in FIG. 14, there is a smaller temperature range in the lamp with the annular-type fixing member than with the holder-type fixing member. The temperature swings around the bent portion (point P5) is significantly reduced by using the annular type fixing member.

When the annular lamp-fixing member 70 in FIG. 12 is used, the contact area between the annular lamp-fixing member 70 and the lamp 80 is smaller than the contact area between the holder type lamp-fixing member 20 and the lamp 30. Further, the annular lamp-fixing member 70 is blocked off from the exterior of the container 60. Thus, the amount of heat dissipation, from the bent portion 81 to the environment outside the container 60 is decreased. With less heat dissipation, formation of a temperature gradient within the lamp 80 is less likely.

As a result, the mercury flow in the lamp 80 is substantially suppressed and the non-uniform luminance caused by the luminance decrease from the region having the relatively low mercury concentration may be solved.

When the annular lamp-fixing member 70 is used, the first and second straight portions 82 and 83 are positioned on the same plane relative to the bottom face 61 of the container by hooking a central portion of the bent portion 81 of the lamp 80 with the annular lamp-fixing member 70. Preferably, the first and second straight portions 82 and 83 lie flat on the bottom face 61 so that they are the same distance away from the bottom surface 61 instead of being tilted.

When the fixing member 70 is not used on lamp 80, the first and second straight portions 82 and 83 tilt relative to the bottom face 61 of the container 60 such that the two portions are different distances away from the bottom face 61. In this case, a leakage current flows through whichever one of the first and second straight portions 82 and 83 that is closer to the container 60. Thus, the tilting of that the lamps 80 causes the backlight assembly employing the annular lamp-fixing member 70 to have reduced electrical efficiency.

When the annular lamp-fixing member 70 is employed in the backlight assembly, the lamp 80 may hit the lamp-inserting portion 91 of the mold frame 90 in response to a vibration caused by something in the environment. This impact may damage the lamp 80. For example, interference noises caused by a sound coming from a speaker in a display device may adversely affect the luminance characteristics of the backlight assembly.

If an additional fixing member were used to prevent the lamp 80 from tilting, there would be an additional process during manufacturing and assembly to fix the additional member. This would result in an increased cost for manufacturing the backlight assembly.

Referring again to FIG. 1, the above-mentioned problems are solved by the mold frame 100. In the mold frame 100, the lamp-fixing members 122 are part of the lamp-inserting portions 121 of the second face 120. Thus, the secure fixing of the lamps is achieved with the mold frame 100, eliminating the need for a separate fixing member.

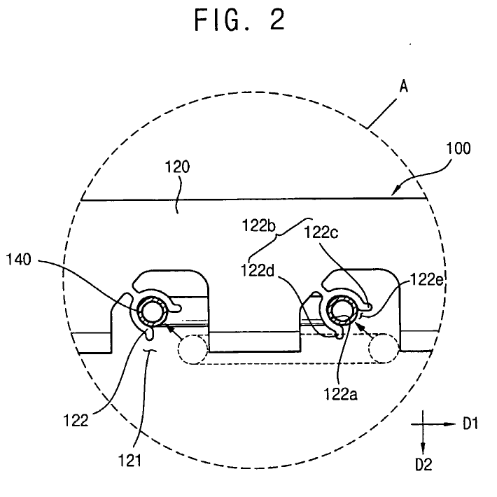

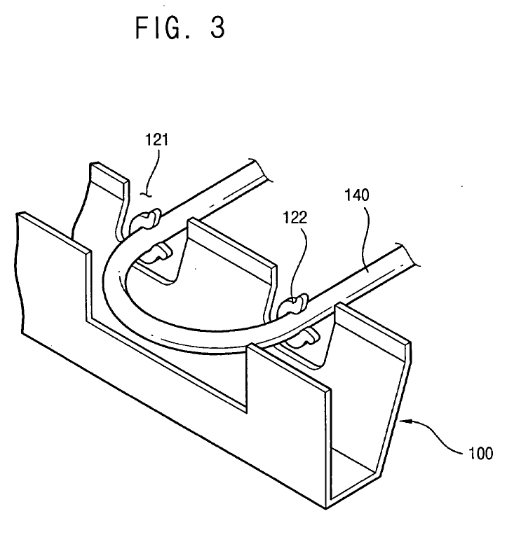

FIG. 2 is an enlarged front view of a portion “A” in FIG. 1 and FIG. 3 is a perspective view illustrating a lamp fixed to a lamp-fixing member.

Referring to FIGS. 1 and 2, the lamp-inserting portions 121 into which the lamps 140 are inserted are formed at the second face 120 of the mold frame 100. Each of the lamp-fixing members 122 is positioned in each of the lamp-inserting portions 121.

The lamp-inserting portions 121 is generally a U-shaped notch on one edge of the second face 120. This edge makes contact with the bottom face of a container (not shown).

The lamp-fixing members 122 extend from the second face 120 and are positioned in a region defined by the lamp-inserting portions 121. For example, the lamp-fixing members 122 protrude downward (toward the edge of the second face 120) from a corner of the U-shaped notch in the lamp-inserting portions 121. Each of the lamp-fixing members 122 includes a holding portion 122a and a guiding portion 122b.

The holding portion 122a has an opening 122e into which the lamp 140 is inserted. The holding portion 122a may include an elastic material. For example, when the mold frame 100 includes polycarbonate (PC), the lamp-fixing member 122 includes PC as well.

The lamp 140 is placed adjacent to the opening 122e of the lamp-fixing member 122. The lamp 140 is then pressed toward the holding portion 122a so that the opening 122e is widened due to the elasticity of the lamp-fixing member 122, allowing the lamp 140 to “snap” into the holding portion 122a.

The guiding portion 122b guides the lamp 140 into the holding portion 122a. The guiding portion 122b includes a first portion 122c extending from one end of the holding portion 122a in a first direction D1, that is, in a short-axis direction of the holding portion 122a, and a second portion 122d extending from another end of the holding portion 122a in a second direction D2, that is, in a long-axis direction of the holding portion 122a, substantially perpendicular to the first direction D1.

When the lamp 140 is placed adjacent to the opening 122e and pressed, the guiding portion 122b prevents the lamp 140 from slipping out of the opening 122e. That is, the guiding portion 122b facilitates a secure assembly of the lamp 140 and the lamp-fixing member 122.

The orientation of the opening 122e, that is, the direction in which the lamp 140 is pressed to be secured in the holding portion 122a, is shown by an arrow in FIG. 2. This direction preferably corresponds to a line that divides the angle between the first and second directions D1 and D2 into two equal angles. The orientation of the opening 122e prevents the lamp 140 from being separated from the lamp-fixing member 122, for example due to vibrations along the first and second directions D1 and D2 that is caused by an external impact.

Furthermore, when the lamp 140 is pressed into the holding portion 122a, the holding portion 122a expands to widen the opening 122e. The force of the holding portion 122a returning to its original shape after the momentary widening is applied to the lamp 140 inserted into the holding portion 122a so that the holding portion 122a firmly secures the lamp 140 as shown in FIG. 3.

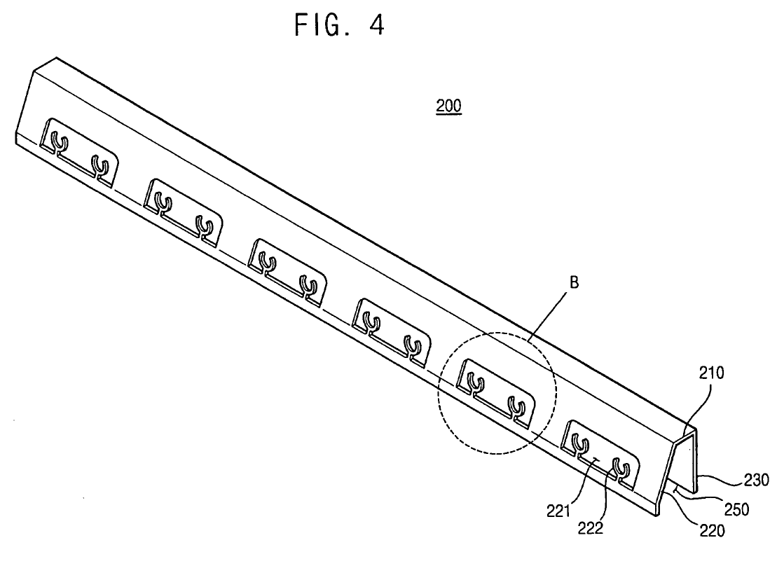

FIG. 4 is a perspective view illustrating a mold frame in accordance with one embodiment of the present invention.

Referring to FIG. 4, a mold frame 200 of this embodiment includes a first face 210 for supporting optical members (not shown) and a second face 220 extending from the first face 210 to fix lamps.

The mold frame 200 may further include a third face 230 extending from the first face 210.

When the mold frame 200 includes the third face 230, the third face 230 makes contact with an inner wall of a container (not shown) in which the mold frame 200 is received to support the mold frame 200. Further, the third face 230 provides the lamps and the optical members with a gap. In this embodiment, the third face 230 is arranged in a plane that is substantially perpendicular to a bottom face of the container and substantially parallel to the inner wall of the container.

The first face 210 is formed between upper ends of the second face 220 and the third face 230 to support the optical members. The first face 210 may extend in a direction substantially perpendicular to the second face 220. Thus, the first face 210 is substantially parallel to the bottom face of the container to support the optical members.

The second face 220 extends from the first face 210. The end of the each lamp is received in a space 250 defined by the first to third faces 210, 220 and 230 so that the dark field, which may be formed at the end of each lamp, is covered with the mold frame 200.

Further, the second face 220 may be inclined with respect to eh first face 210. The incline is designed to reflect the light from the lamps in an upward direction, thereby improving luminance characteristics of the backlight assembly. In addition, a reflection member (not shown) may be formed on the inclined face to further improve the luminance characteristics of the backlight assembly.

The second face 220 has lamp-inserting portions 221 into which the end of each lamp is inserted. The end of each lamp inserted into the lamp-inserting portions 221 is positioned in the space 250 defined by the first to third faces 210, 220 and 230. Lamp-fixing members 222 are arranged in the lamp-fixing portions 221, respectively. The lamp-inserting portions 221 include a rectangular cutout formed through the second face 220.

Hereinafter, the lamp-inserting portions 221 and the lamp-fixing members 222 are illustrated in detail.

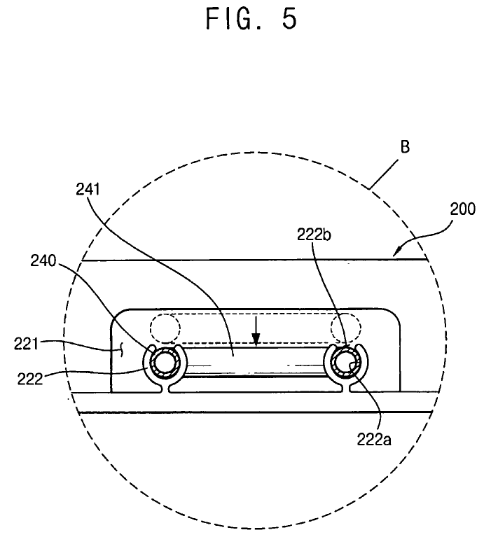

FIG. 5 is an enlarged front view of a portion “B” in FIG. 4.

Referring to FIGS. 4 and 5, the lamp-inserting portions 221 are formed through the second face 220 of the mold frame 200. Each of the lamp-fixing members 222 is arranged in each of the lamp-inserting portions 221.

The lamp-inserting portions 221 correspond to a hole that extends from the edge of the second face 220 that makes contact with a bottom face of a container (not shown) toward the first face 210. In this embodiment, the lamp-inserting portions 221 have a rectangular shape.

The lamp-fixing members 222 extend from the second face 220 and are positioned in a region defined by the lamp-inserting portions 221. Here, when the lamp-inserting portions 221 have a rectangular shape with four sides: a first side extending in the same direction as the length of the first face 210, a second side parallel to the first side but farther away from the first face 210 than the first side, and a third side and a fourth side between the first and second sides. The lamp-fixing members 222 protrude from the second side toward the first side.

When the lamp 240 includes a U-shaped CCFL, two lamp-fixing members 222 are used to fix one lamp 240.

Each of the lamp-fixing members 222 includes a holding portion 222a. The holding portion 222a has an opening 222b into which the lamp 240 is inserted. The holding portion 222a may be made of an elastic material. For example, when the mold frame 200 includes polycarbonate (PC), the lamp-fixing member 222 also includes PC.

The lamp 240 is placed adjacent to the opening 222b of the lamp-fixing member 222. The lamp 240 is then pressed toward the holding portion 222a so that the opening 222a is widened due to the elasticity of the lamp-fixing member 222, thereby allowing the lamp 240 to “snap” into the holding portion 222a.

Additionally, the lamp-fixing member 222 may include a guiding portion (not shown) substantially identical to that in FIG. 2. However, as shown in FIG. 5, a bent portion 241 of the U-shaped lamp is positioned over the lamp-fixing member 222 to insert the lamp 240 into the lamp-inserting portion 221. The lamp is then pressed toward the holding portion 222a (i.e., in a downward direction in FIG. 5). Since the lamp pressed (downward) toward the holding portion 222a, a guiding portion is not necessary for the lamp-fixing member 222.

When the lamp 240 is pressed into the holding portion 222a, the holding portion 222a expands to widen the opening 222b. The force of the holding portion 222a returning to its original shape after the momentary widening is applied to the lamp 240 inserted into the holding portion 222a so that the holding portion 222a firmly secures the lamp 240.

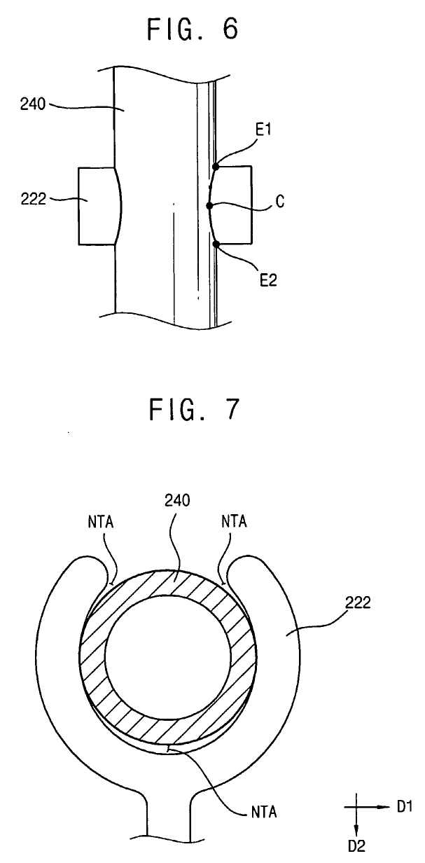

FIG. 6 is a front view illustrating configurations of a lamp-fixing member with which the lamp is assembled in accordance with one embodiment of the present invention. More specifically, FIG. 6 shows the holding portion 222a holding the lamp 240 as viewed from the opening 222b. FIG. 7 is a side view illustrating the lamp-fixing member in FIG. 6. For simplicity of description, the lamp-fixing member of FIG. 4 is depicted in FIGS. 6 and 7. However, it should be understood that the configurations disclosed in FIG. 6 and FIG. 7 is not limited to being used with the lamp-fixing member of FIG. 4.

Referring to FIGS. 4 and 6, the lamp-fixing member 222 has substantially same thickness as that of the second face 220. Further, the holding portion 222a of the lamp-fixing member 222 has a rounded inner surface making contact with the lamp 240. Thus, the rounded inner surface has end portions E1 and E2, and a central portion C that is thicker than the end portions E1 and E2.

Here, the shape of the holding portion 222a requires only the convex central portion C curved toward the end portions E1 and E2. Any shape connecting the central portion C to the end portions E1 and E2 may be used for the holding portion 222a.

The rounded shape of the central portion C of the holding portion 222a reduces the contact area between the lamp-fixing member 222 and the lamp 240. As a result of the decreased contact area, heat does not transfer as easily to the lamp-fixing member 222 from the lamp 240, and heat dissipation is less effective. Hence, formation of temperature gradient in the lamp 240 is less of a concern.

Referring to FIG. 7, the holding portion 222a has a semi-circular shape in order to reduce the contact area between the lamp-fixing member 222 and the lamp 240. Since the holding portion 222a has a semi-circular shape and is made of an elastic material, the holding portion 222a applies a force in the first direction D1 and partially contacts the lamp 240. As shown in FIG. 7, non-contact regions NTA are formed between the lamp 240 and the holding portion 222a. As a result, the contact area between the lamp 240 and the lamp-fixing member 222 is decreased according to the shape of the holding portion 222a, further reducing heat transfer between the lamp 240 and the lamp-fixing member 222.

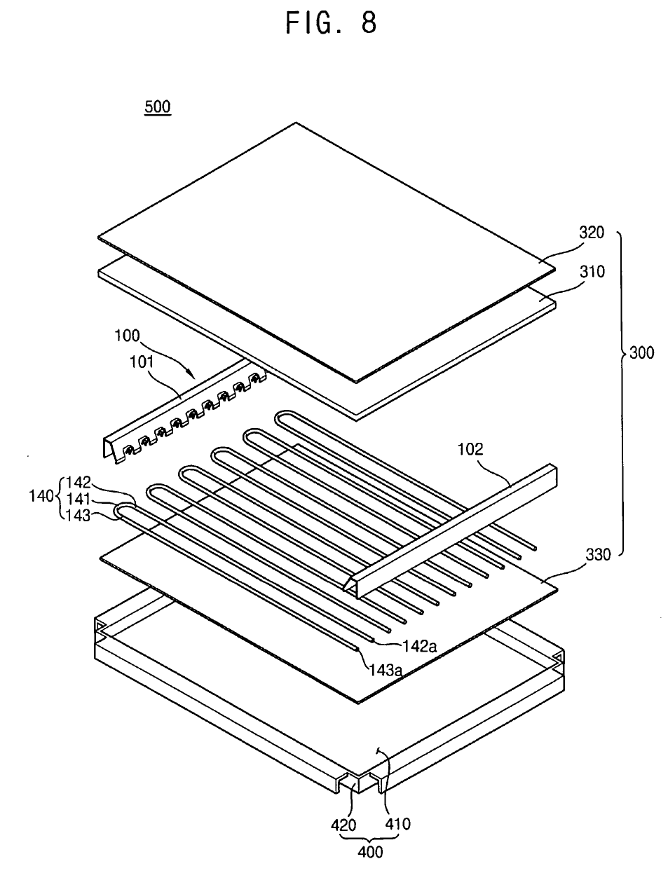

FIG. 8 is an exploded perspective view illustrating a backlight assembly in accordance with one embodiment of the present invention. Referring to FIG. 8, a backlight assembly 500 of this embodiment includes a mold frame 100, a plurality of lamps 140, optical members 300, and a container 400. The optical members 300 include a diffusion plate 310, an optical sheet 320 and a reflection plate 330. The lamps 140 may include a U-shaped CCFL.

The container 400 includes a bottom face 410 and sidewalls 420 extending upward from edge portions of the bottom face 410. The bottom face 410 and the sidewalls 420 define a space in which the mold frame 100, the lamps 140 and the optical members 300 are received.

The diffusion plate 310 and the optical sheet 320 are sequentially arranged on the lamps 140. The diffusion plate 310 and the optical sheet 320 diffuse light emitted from the lamps 140 to improve luminance uniformity and a viewing angle of the backlight assembly 500.

The reflection plate 330 is arranged between the lamps 140 and the bottom face 410 of the container 400. The reflection plate 330 reflects lights that leaking from the lamps 140 back toward the diffusion plate 310 to improve the light efficiency of the backlight assembly 500.

The mold frame 100 includes a first side mold 101 and a second side mold 102. The first side mold 101 covers a bent portion 141 of the lamp 140. The second side mold 102 covers the ends of straight portions 142 and 143 of the each lamp 140, which are indicated as a first end 142a and a second end 143a in FIG. 8.

The first side mold 101 includes substantially the same elements as those of the mold frame in FIGS. 1 to 7.

The second side mold 102 may be shaped substantially identical to that of the first side mold 101. That is, the second side mold 102 may include lamp-inserting portions (not shown) into which the first and second ends 142a and 143a are inserted and lamp-fixing members (not shown) that are shaped substantially identical to the lamp-fixing members in the mold frame of FIGS. 1 to 7. The lamp-fixing members are arranged in the lamp-inserting portions.

In an embodiment where a connector for supplying power to the first and second ends 142a and 143a has a holder shape, the lamp-fixing members may be omitted from the second side mold 102.

In the embodiment of FIG. 8, the mold frame 100 is a separate, free-standing component that is combined with other components during the assembly of the backlight assembly 500. In an alternative embodiment, the mold frame 100 may be integrally formed as part of the container 400. Particularly, the mold frame 100 may be integrally formed as part of the container 400 by being connected with one or more of the sidewalls 420. Preferably, the third face 130 of the mold frame 100 is integrated with a sidewall that extends along the bent portion 141 or the first and second ends 142a and 143a of the straight portions 142 and 143 of the lamp 140.

Accordingly, when the first and second faces 110 and 120 of the mold frame 100 extend from the sidewalls 420 of the container 400 and the lamp-fixing members are provided on the second face 120, the integrated mold frame exhibits substantially the same effect as a separate or free-standing mold frame.

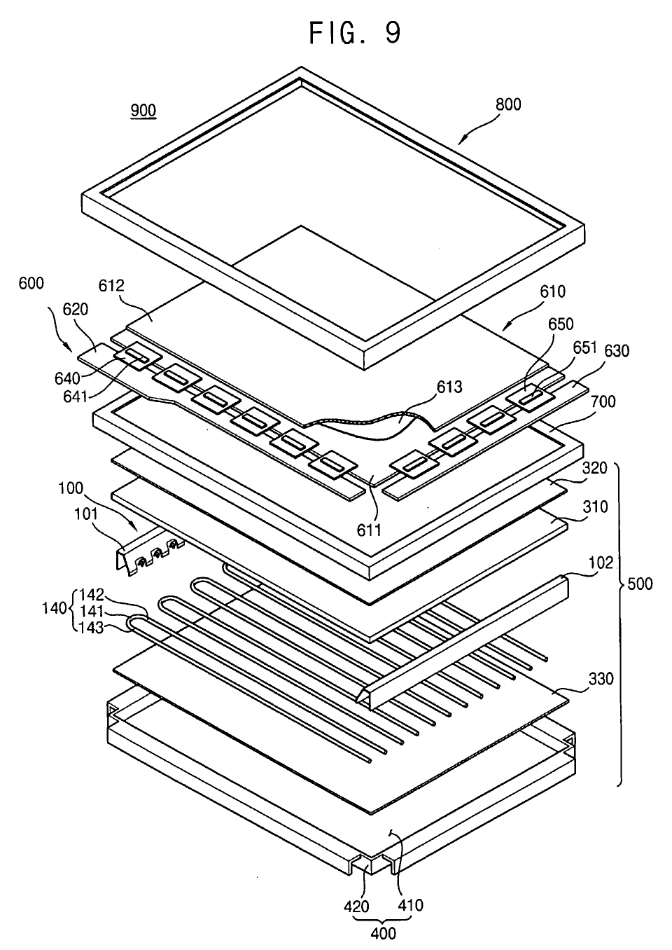

FIG. 9 is an exploded perspective view illustrating a display device in accordance with one embodiment of the present invention.

Referring to FIG. 9, a display device 900 of this embodiment includes a backlight assembly 500 for emitting lights and a display panel assembly 600 for displaying an image using the lights.

The backlight assembly 500 provides the display panel assembly 600 with light. Since the backlight assembly 500 is illustrated with reference to FIGS. 1 to 8, further description with respect to the backlight assembly 500 will not be provided.

The display panel assembly 600 includes a liquid crystal display (LCD) panel 610 for displaying the image, data and gate printed circuit boards (PCBs) 620 and 630, and data and gate flexible films 640 and 650. The data and gate PCBs 620 and 630 are electrically connected to the LCD panel 610 through the data and gate flexible films 640 and 650, respectively. Data and gate driving chips 641 and 651 are mounted on the data and gate flexible films 640 and 650. The data and gate driving chips 641 and 651 convert control signals provided from the data and gate PCBs 620 and 630 into driving signals for driving the LCD panel 610. The data and gate driving chips 641 and 651 then outputs the driving signals to the LCD panel 610.

The LCD panel 610 includes a thin film transistor (TFT) substrate 611, a color filter substrate 612 combined with the TFT substrate 611, and a liquid crystal (LC) layer 613 interposed between the TFT substrate 611 and the color filter substrate 612.

The TFT substrate 611 includes a transparent glass substrate on which TFTs (not shown) are arranged in a matrix pattern. Each of the TFTs includes a source terminal (not shown) electrically connected to a data line (not shown), a gate terminal (not shown) electrically connected to a gate line (not shown), and a drain terminal (not shown) electrically connected to a pixel electrode (not shown). The pixel electrode is made of a transparent conductive material.

The color filter substrate 612 includes red, green and blue pixels (not shown), and a common electrode including a transparent conductive material.

The display device 900 further includes a guide frame 700 and a top chassis 800. The guide frame 700 is arranged between the backlight assembly 500 and the LCD panel 610 to firmly secure the diffusion plate 310 and the optical sheet 320 and to guide the receiving positions of the LCD panel 610.

The top chassis 800 covers the edge portions of the LCD panel 610. The top chassis 800 is combined with the container 400 to place the LCD panel 610 over the backlight assembly 500. The top chassis 800 prevents the LCD panel from being damaged by external impact and also from being separated from the backlight assembly 500.

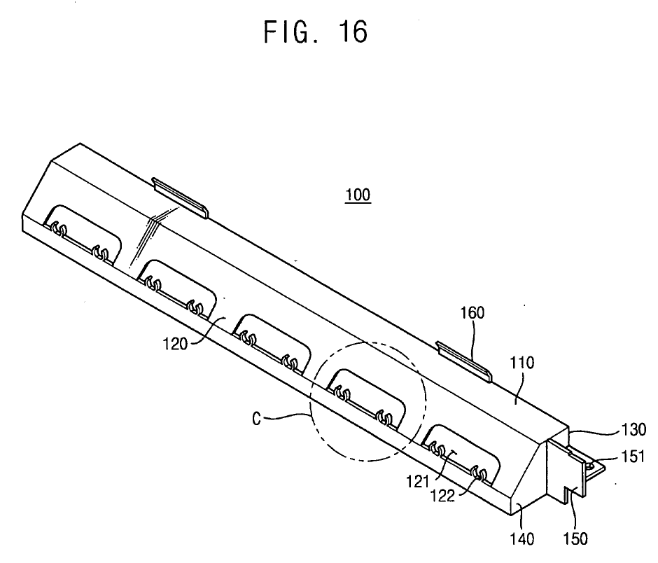

FIG. 16 is a perspective view illustrating a mold frame in accordance with one embodiment of the present invention.

Referring to FIG. 16, a different embodiment of the mold frame 100 shown in FIG. 1 is shown. As described above in reference to FIG. 1, the mold frame 100 includes the first face 110 for supporting optical members (not shown) and the second face 120 having lamp-fixing members 122 that fixes lamps (not shown). The lamp-fixing members 122 are spaced apart from the intersection of the first and second faces 110 and 120 to provide a gap between the lamps and the optical members.

The mold frame 100 may further include a third face 130 extending from another end of the first face 110, as explained above in reference to FIG. 1.

When the mold frame 100 includes the third face 130, the third face 130 makes contact with an inner wall of a container (not shown) in which the mold frame 100 is received to support the mold frame 100. In this example embodiment, the third face 130 is arranged in a direction substantially perpendicular to a bottom face of the container and substantially parallel to the inner wall of the container.

Further, the mold frame 100 may include a fourth face 140 extending from any one of the second and third faces 120 and 130, and a fifth face 150 protruding from the fourth face 140.

When the mold frame 100 includes the fourth face 140, the fourth face 140 makes contact with the inner wall of a container in which the mold frame 100 is received to support the mold frame 100. In this embodiment, the fourth face 140 is arranged in a direction substantially perpendicular to the bottom face of the container and substantially parallel to the inner wall of the container. Further, the fifth face 150 functions to secure the mold frame 100 to the inner wall of the container. Here, the fifth face 150 may include a fixing hole 151 for fixing the mold frame 100 to the inner wall of the container.

The first face 110 extends from the second face 120 or the third face 130 to support the optical members. The first face 110 may lie in a plane that is substantially perpendicular to the plane of the third face 130. Thus, the first face 110 is substantially parallel to the bottom face of the container to support the optical members.

The second face 120 extends from the first face 110 at an angle. The end of each lamp is received in the space 150 defined by the first to third faces 110, 120 and 130 so that the light emitted from one end of each of the lamps is covered with the mold frame 100.

The second face 120 may be inclined with respect to the first face 100. The incline is designed to reflect the light from the lamps in an upward direction, thereby improving the luminance characteristics of a backlight assembly. In addition, a reflection member (not shown) may be formed on the inclined face to improve the luminance characteristics of the backlight assembly.

Furthermore, the second face 120 has lamp-inserting portions 121 into which the end of each lamp is inserted. The end of each lamp inserted into the lamp-inserting portions 121 is positioned in a space defined by the first to third faces 110, 120 and 130. Lamp-fixing members 122 for holding the lamps are arranged in the lamp-fixing portions 121, respectively.

The lamp-inserting portions 121 correspond to a rectangular hole formed through the second face 120. Hereinafter, the lamp-inserting portions 121 and the lamp-fixing members 122 are illustrated in detail.

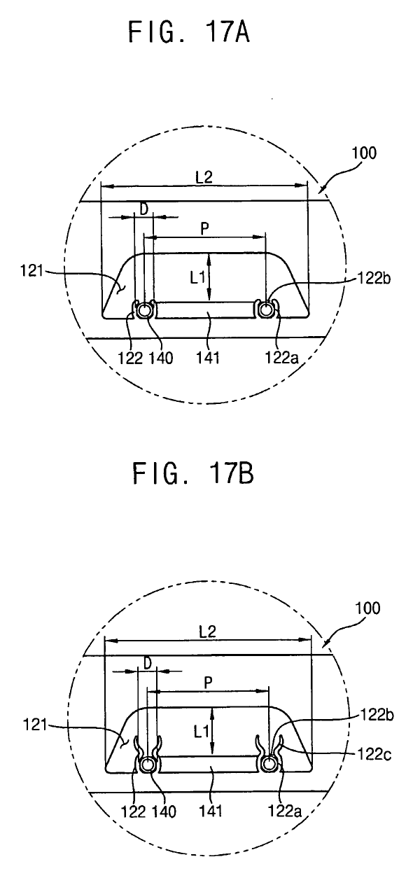

FIG. 17A is an enlarged front view of a portion “C” in FIG. 16 and FIG. 17B is a corresponding view of the portion “C” in FIG. 16 in another embodiment of the present invention.

Referring to FIGS. 16 and 17A, the lamp-fixing members 122 are formed through the second face 120 of the mold frame 100. Each of the lamp-fixing members 122 is arranged in each of the lamp-inserting portions 121.

The lamp-inserting portions 121 correspond to a cutout that extends from one end of the second face 120, which makes contact with a bottom face of a container (not shown) toward the first face 110. In this embodiment, the lamp-inserting portions 121 have a rectangular shape.

The lamp-fixing members 122 extend from the second face 120 and are positioned in a region defined by the lamp-inserting portions 121. In this embodiment, the lamp-fixing members 122 extend upward from a lower side of the lamp-inserting portions 121. In other embodiments, the lamp-fixing members may extend from an upper side of the lamp-inserting portions 121 in a downward direction, from a left side of the lamp-inserting portions 121 toward a right direction or from a right side of the lamp-inserting portions 121 to a left direction.

When the lamp 140 includes a U-shaped CCFL, the two lamp-fixing members 122 for holding the lamp 140 are arranged in the single lamp-inserting portion 121.

Each of the lamp-fixing members 122 includes a holding portion 122a. The holding portion 122a has an opening 122b into through which the lamp 140 is “snapped” in. The holding portion 122a may be made of an elastic material. For example, when the mold frame 100 includes polycarbonate (PC), the lamp-fixing member 122 also includes PC. Alternatively, the mold frame 100 may be made of a resin that is treated by an injection molding process.

The lamp 140 is placed in the lamp-fixing member 122 through the opening 122b. Specifically, the lamp 140 is pressed into the holding portion 122a so that the pressure momentarily widens the opening 122b made of an elastic material. This momentary widening of the opening 122b allows the lamp 140 to “snap” into the holding portion 122a.

Referring to FIGS. 16 and 17B, the lamp-fixing member 122 may further include guiding portions 122c. The guiding portions 122c have bent ends for receiving the lamp 140. The guiding portions 122c guide the insertion of the lamp 140 into the holding portion 122a. Thus, the guiding portions 122c “flare” out from both ends of the holding portion 122a. When the lamp 140 is placed adjacent to the opening 122b and pressed, the guiding portion 122c prevents the lamp 140 from slipping off or being misaligned with the opening 122b. That is, the guiding portion 122c facilitates the assembly of the lamp 140 and the lamp-fixing member 122. However, as shown in FIG. 17A, to insert the lamp 140 into the lamp-inserting portion 121, a bent portion 141 of the U-shaped lamp is positioned over the lamp-fixing member 122 and pressed toward the holding portion 122a (i.e., downward). Where the lamp is pressed downward, the guiding portion 122c may be omitted.

As described above, when the lamp 140 is pressed, the holding portion 122a expands momentarily with the widening of the opening 122b. The force of the holding portion 122a returning to its original shape after the momentary widening is applied to the lamp 140 inserted into the holding portion 122a so that the holding portion 122a firmly secures the lamp 140.

In this example embodiment, a first length L1 between an upper face of the lamp-inserting portion 121 and the lamp 140, a second length L2 of the lamp-inserting portion 121, a diameter D of the lamp 140 and a pitch P between the lamps 140 have relations as follows.
L1>D Equation 1

The first length L1 is longer than the diameter D. That is, a width of the lamp-inserting portion 121 is more than twice as big as the diameter D. To insert the lamp into the lamp-inserting portion 121, it is required to provide the lamp-inserting portion 121 with the first length L1 longer than the diameter D of the lamp 140.
L2>P+a thickness of the lamp-fixing member Equation 2

The second length L2 is longer than a length that is a sum of the pitch P, the diameter D and the thickness of the lamp-fixing member 122. That is, a summed value of the pitch P and the thickness of the lamp-fixing member 122 corresponds to a minimum value of the second length L2 of the lamp-inserting portion 121. In order to assure the insertion of the lamp 140 into the lamp-inserting portion 121, it is required to provide the lamp-inserting portion 121 with the second length L2 substantially equal to or longer than the combined length of the pitch P and the thickness of the lamp-fixing member 122.

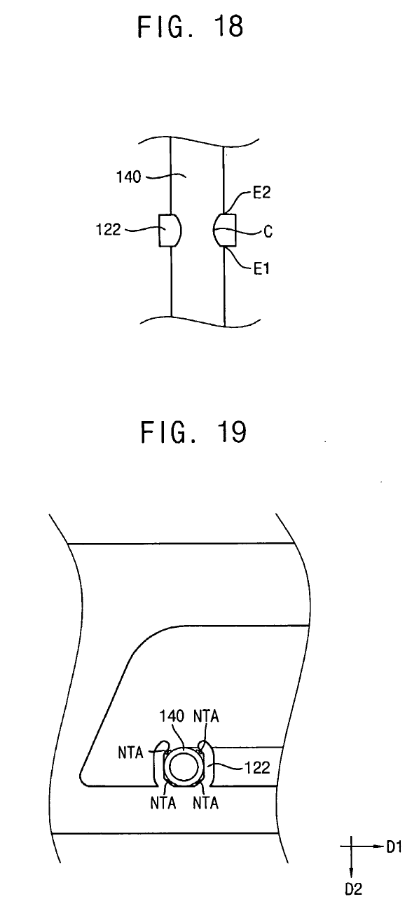

FIG. 18 is a front view illustrating configurations of a lamp-fixing member with which the lamp is assembled in accordance with one embodiment of the present invention. More specifically, FIG. 18 shows the lamp-fixing member 122 holding the lamp 140 as viewed from the opening in the lamp-fixing member 122. FIG. 19 is a side view illustrating the lamp-fixing member of FIG. 18.

Referring to FIGS. 16 and 18, the lamp-fixing member 122 has substantially same thickness as that of the second face 120. Further, the holding portion 122a (see FIG. 17A) of the lamp-fixing member 122 has a rounded inner face making contact with the lamp 140. Thus, the rounded inner surface has both end portions E1 and E2, and a central portion C that is thicker than the end portions E1 and E2. The holding portion 122a is formed such that the central part of the holding portion 122a protrudes inward more than the ends E1 and E2, and the particular shape of the holding portion 122a is not limited to what is shown in FIG. 18.

Referring to FIG. 19, although the holding portion 122a generally creates a circular space for the lamp 140, the part of it that contacts the lamp 140 is straight, not curved. The strait part reduces the contact area between the lamp-fixing member 122 and the lamp 140. The holding portion 122a is preferably made of an elastic material. The two arms of the holding portion 122a exert a force pressing the lamp 140 toward each other in a first direction D1, therefore making only partial contact with the lamp 140 while securely holding the lamp 140.

Here, the temperature of the lamp 140 at the contact area between the lamp-fixing member 122 and the lamp 140 is lowered due to heat transfer, and the amount by which the temperature is lowered is proportional to the size of the contact area. As described above, if the temperature of the lamp 140 at the contact area is lower than the temperature at the rest of the lamp 140, a temperature gradient is generated in the lamp 140. The temperature gradient causes the mercury in the lamp to flow, causing a non-uniform distribution of the mercury. This results in a decrease of luminance at the portion of the lamp 140 having a relatively low mercury concentration and ultimately in inefficient luminance characteristics for the backlight assembly as a whole.

In the embodiment of FIG. 19, the straight portion of the holding portion 122a forms non-contact regions NTA between the lamp 140 and the holding portion 122a. The presence of the non-contact regions NTA decreases the contact area between the lamp 140 and the lamp-fixing member 122 to reduce the heat transfer between the lamp 140 and the holding portion 122a. Therefore, the mercury distribution in the lamp 140 remains relatively uniform and the backlight assembly having the lamp-fixing member 122 has improved luminance characteristics.

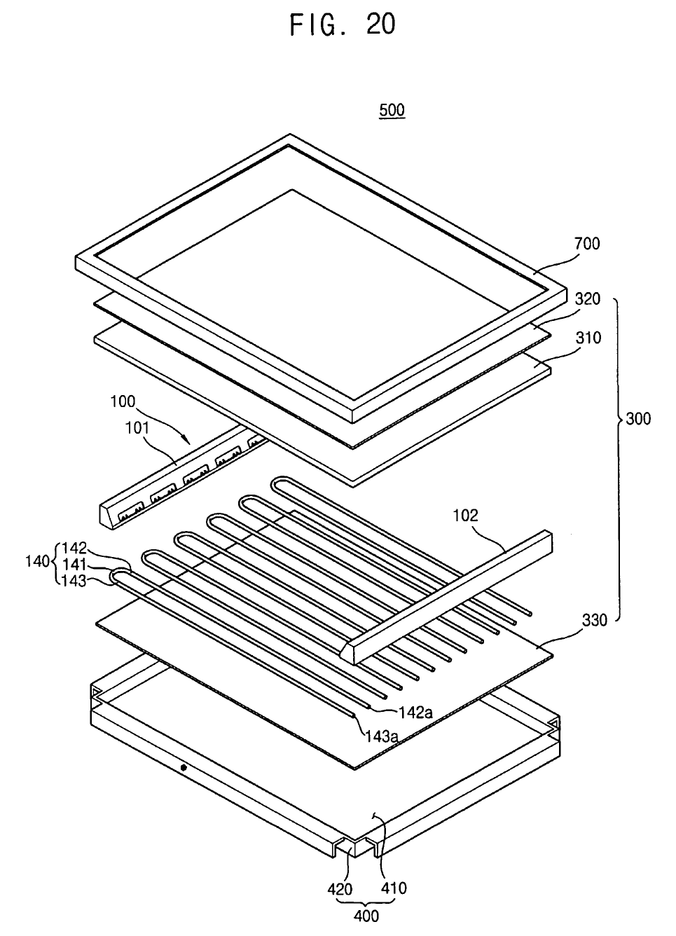

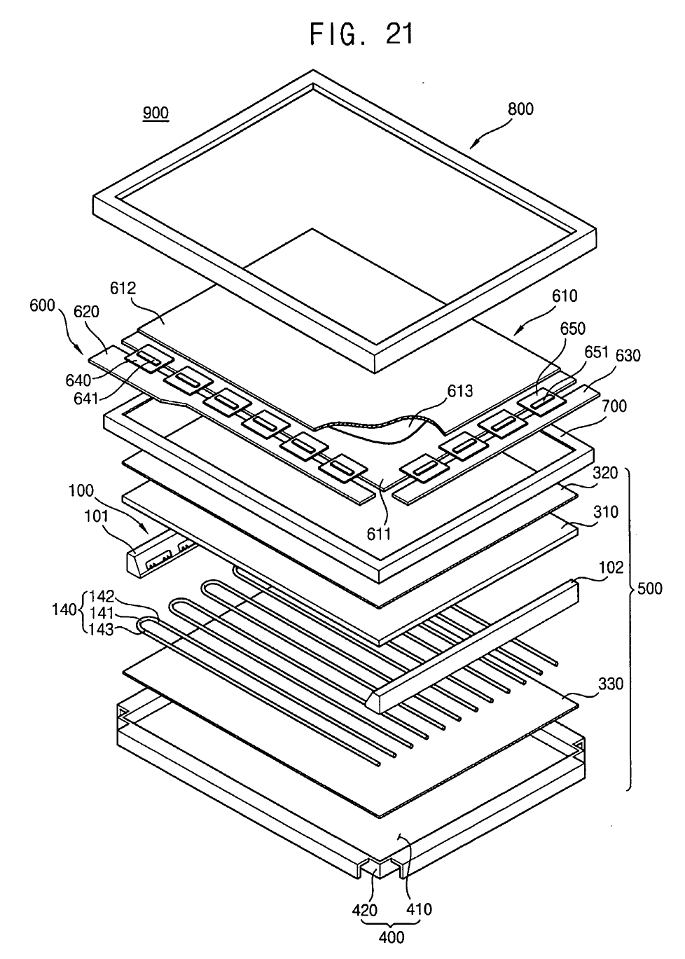

FIG. 20 is an exploded perspective view illustrating a backlight assembly in accordance with one embodiment of the present invention.

The mold frame of this embodiment includes substantially the same elements as those in the mold frame in FIGS. 1 to 7. Here, the reference numerals refer to the same elements, hence any further illustrations with respect to the same elements are omitted herein for brevity.

Referring to FIG. 20, the backlight assembly 500 of this embodiment includes the mold frame 100, the lamps 140, the optical members 300, and the container 400 similar to the embodiment of FIG. 8. The optical members 300 includes the diffusion plate 310, the optical sheet 320 and the reflection plate 330. The lamps 140 may be U-shaped CCFLs. In addition to the components already described in reference to FIG. 8, the backlight assembly 500 may also have a guide frame 700. The guide frame 700 fixes the diffusion plate 310 and the optical sheet 320 to predetermined positions. Further, the guide frame 700 guides receiving positions of the LCD panel 610 illustrated later.

The container 400 includes the bottom face 410 and sidewalls 420 extending from the edge portions of the bottom face 410. The bottom face 410 and the sidewalls 420 define a space in which the mold frame 100, the lamps 140 and the optical members 300 are received.

The diffusion plate 310 and the optical sheet 320 are sequentially arranged on the lamps 140. The diffusion plate 310 and the optical sheet 320 diffuse the light emitted from the lamps 140 to improve luminance uniformity and a viewing angle of the backlight assembly 500.

The reflection plate 330 is arranged between the lamps 140 and the bottom face 410 of the container 400. The reflection plate 330 reflects light that leaks from the lamps 140 back toward the diffusion plate 310 to improve light efficiency of the backlight assembly 500.

Like in the embodiment of FIG. 8, the mold frame 100 includes the first side mold 101 and the second side mold 102. The first side mold 101 covers a bent portion 141 of the each lamp 140. The second side mold 102 covers the ends 142a, 143a of straight portions 142 and 143 of the lamp.

Here, the first side mold 101 is substantially the same as that in FIGS. 16 to 19. Thus, no description will be provided for the first side mold 101 in the interest of minimizing redundancy.

The second side mold 102 may be shaped substantially identical to that of the first side mold 101. That is, the second side mold 102 may include lamp-inserting portions (not shown) into which the first and second ends 142a and 143a are inserted, and lamp-fixing members (not shown) that have a shape substantially identical to that of the lamp-fixing members in the mold frame of FIGS. 1 to 7 arranged in the lamp-inserting portions.

Where a connector for supplying power to the first and second ends 142a and 143a has a holder shape, the lamp-fixing members may be omitted from the second side mold 102.

In this embodiment, the mold frame 100 is a separate, free-standing component that is combined with other components during the assembly of the backlight assembly 500. In an alternative embodiment, the mold frame 100 may be integrally formed as part of the container 400. Particularly, the mold frame 100 may be integrated with the container 400 by being connected with one or more of the sidewalls 420. Preferably, the third face 130 of the mold frame 100 is integrated with a sidewall that extends along the bent portion 141 or the first and second ends 142a and 143a of the straight portions 142 and 143 of the lamp 140.

Accordingly, when the first and second faces 110 and 120 of the mold frame 100 extend from the sidewalls 420 of the container 400 and the lamp-fixing members are provided on the second face 120, the integrated mold frame exhibits substantially the same effect as a separate, free-standing mold frame.

FIG. 21 is an exploded perspective view illustrating a display device in accordance with one embodiment of the present invention. The

Referring to FIG. 21, the display device 900 includes the backlight assembly 500 for emitting lights, and the display panel assembly 600 for displaying an image using the lights.

The backlight assembly 500 provides the display panel assembly 600 with light. The backlight assembly 500 is illustrated with reference to FIGS. 16 to 20.

The display panel assembly 600 is described above, in reference to FIG. 9, as are its components such as the LCD panel 610, the TFT substrate 611, and the color filter substrate 612. In the interest of minimizing redundancy, descriptions of these parts will not be repeated.

Although the a mold frame that is designed to be used with U-shaped CCFL is described herein, as well as the backlight assembly and the display device made with the mold frame, it will be apparent to a person skilled in the art to apply the mold frame to a tubular CCFL.

According to the present invention, the straight portions of the U-shaped CCFL connected to the bent portion of the CCFL are arranged parallel to each other using the lamp-fixing member of the mold frame so that leakage currents are reduced. As a result, the backlight assembly having the U-shaped CCFL may have improved light efficiency.

Further, the lamp-fixing member of the mold frame reduces or prevents formation of a temperature gradient in the lamp so that the backlight assembly having the mold frame may have uniform luminance. As a result, the display device having he backlight assembly may have improved display quality.

Having described the example embodiments of the present invention and its advantages, it is noted that various changes, substitutions and alterations can be made herein without departing from the spirit and scope of the invention as defined by appended claims.

What is claimed is:

1. A mold frame covering ends of a plurality of lamps and supporting an optical member, the mold frame comprising:
a first face supporting the optical member; and
a second face extending from the first face, the second face including lamp-inserting portions into which the ends of the lamps are inserted, and lamp-fixing members arranged in the lamp-inserting portions to support the lamps.

2. The mold frame of claim 1, further comprising a third face extending from a different edge of the first face than the second face.

3. The mold frame of claim 1, wherein the lamp-fixing members extend from the second face and are positioned in a region defined by the lamp-inserting portions.

4. The mold frame of claim 3, wherein the lamp-fixing members extend from a part of the lamp-inserting portions that is closest to the first face toward an edge of the second face that does not interface the first face.

5. The mold frame of claim 4, wherein the lamp-inserting portions are cutouts formed on the second face.

6. The mold frame of claim 1, wherein the lamp-fixing members extend from a side of the lamp-inserting portions.

7. The mold frame of claim 1, wherein the lamp-inserting portions have a rectangular cutout formed through the second face.

8. The mold frame of claim 1, wherein the lamp-fixing members comprise a holding portion that wraps around each of the lamps.

9. The mold frame of claim 8, wherein the holding portion has a rounded inner face making contact with the lamp.

10. The mold frame of claim 8, wherein the holding portion comprises two arms that form a semi-circular shape, and at least one of the lamps is supported by the two arms exerting a force toward each other.

11. The mold frame of claim 8, wherein the lamp-fixing members further comprise:
a first guiding portion extending from the holding portion in a first direction; and
a second guiding portion extending from the holding portion in a second direction substantially perpendicular to the first direction.

12. The mold frame of claim 1, wherein the first and second faces comprise polycarbonate.

13. A backlight assembly comprising:
lamps emitting light;
optical members arranged on the lamps to improve luminance characteristics of the light; and
a mold frame covering ends of the lamps, the mold frame including lamp-inserting portions into which the ends of the lamps are inserted, and lamp-fixing members arranged in each of the lamp-inserting portions to support the lamps.

14. The backlight assembly of claim 13, wherein the mold frame comprises:
a first face supporting the optical member; and
a second face extending from the first face and having the lamp-fixing members.

15. The backlight assembly of claim 14, wherein the mold frame further comprises a third face extending from the first face and facing the second face.

16. The backlight assembly of claim 14, further comprising a container in which the lamps and the optical members are received,
wherein the mold frame is integrally formed with the container.

17. The backlight assembly of claim 14, wherein the lamp-fixing members extend from a part of the lamp-inserting portions that is closest to the first face toward an edge of the second face that does not interface the first face.

18. The backlight assembly of claim 14, wherein the lamp-fixing members extend from parts of the lamp-inserting portions that are farthest from the first face toward the first face.

19. The backlight assembly of claim 13, wherein each of the lamp-fixing members include a holding portion into which one of the lamps is inserted, the holding portion having a rounded inner surface that makes contact with the lamp.

20. The backlight assembly of claim 13, wherein at least one of the lamps has a U-shape.

21. The backlight assembly of claim 13, wherein at least one of the lamps has a tubular shape.

22. A display device comprising:
lamps emitting light;
optical members arranged on the lamps to improve luminance characteristics of the light;
a mold frame covering end of the lamps, the mold frame including lamp-inserting portions into which the ends of the lamps are inserted, and lamp-fixing members arranged in the lamp-inserting portions to support the lamps; and
a display panel arranged on the optical members to display an image using the light that passes through the optical members.

23. A mold frame covering ends of a plurality of lamps and supporting an optical member that is arranged on the lamps, comprising:
a first face supporting the optical member; and
a second face extending from the first face, the second face including lamp-inserting portions into which the ends of the lamps are inserted, and lamp-fixing members arranged in the lamp-inserting portions to support the lamps, wherein at least one of the lamp-fixing members has a curved portion and a straight portion and the straight portion contacts one of the lamps.

24. The mold frame of claim 23, further comprising a third face extending from a different edge of the first face than the second face.

25. The mold frame of claim 23, wherein the lamp-fixing members extend from the second face and are positioned in a region defined by the lamp-inserting portions.

26. The mold frame of claim 25, wherein the lamp-fixing members extend from a part of the lamp-inserting portions that is close to the first face toward an edge of the second face that does not interface the first face.

27. The mold frame of claim 26, wherein the lamp-inserting portions include a rectangular cutout formed through the second face.

28. The mold frame of claim 23, wherein the lamp-fixing members comprise holding portions into which the lamps are inserted.

29. The mold frame of claim 28, wherein the lamp-fixing members further comprise guiding portions having bent ends to guide the lamps into the holding portions.

30. The mold frame of claim 23, wherein the first and second faces comprise an elastic material.

31. The mold frame of claim 30, wherein the first and second faces comprise polycarbonate.

32. The mold frame of claim 23, wherein the lamp-inserting portions have a width that is at least twice the diameter of the lamp.

33. The mold frame of claim 23, wherein each of the lamp-inserting portions have a length greater than a sum of a pitch of the lamps and a thickness of one of the lamp-fixing members.

34. The mold frame of claim 23, wherein each of the lamp-inserting portions has a width that is at least twice the diameter of the lamp, and a length greater than a sum of a pitch of the lamps and a thickness of one of the lamp-fixing members.

35. A backlight assembly comprising:
lamps emitting light;
optical members arranged on the lamps to improve luminance characteristics of the light; and
a mold frame covering the ends of the lamps, the mold frame including lamp-inserting portions into which the ends of the lamps are inserted, and a lamp-fixing member arranged in each of the lamp-inserting portions to support one of the lamps and having a straight portion that makes contact with the lamp being supported.

36. The backlight assembly of claim 35, wherein the mold frame comprises:
a first face supporting the optical member; and
a second face extending from the first face and having the lamp-fixing members.

37. The backlight assembly of claim 36, wherein the mold frame further comprises a third face extending from a different edge of the first face than the second face.

38. The backlight assembly of claim 36, wherein the lamp-fixing members extend from a side of the lamp-inserting portions that is farthest from the first face.

39. The backlight assembly of claim 38, wherein the lamp-fixing members comprise holding portions into which the lamps are inserted, the holding portions having rounded inner surfaces that contact the lamps.

40. The backlight assembly of claim 35, wherein at least one of the lamps has a U-shape.

41. The backlight assembly of claim 35, wherein at least one of the lamps has a tubular shape.

42. The backlight assembly of claim 35, wherein the lamp-inserting portions have a width that is at least twice the diameter of one of the lamps.

43. The backlight assembly of claim 42, wherein at least one of the lamp-inserting portions has a length greater than a sum of a pitch of the lamps and a thickness of the lamp-fixing member.

44. A display device comprising:
lamps emitting light;
optical members arranged over the lamps to improve luminance characteristics of the light;
a mold frame covering ends of the lamps, the mold frame including:
lamp-inserting portions into which the ends of the lamps are inserted and
lamp-fixing members arranged in each of the lamp-inserting portions to support the lamps and having at least one straight portion that contacts one of the lamps; and
a display panel arranged over the optical members to display an image using the light that pass through the optical members.

45. The display device of claim 44, wherein the lamp-inserting portions have a width that is at least twice the diameter of the lamp.

46. The display device of claim 45, wherein at least one of the lamp-inserting portions has a length greater than a sum of a pitch of the lamps and a thickness of one of the lamp-fixing members.
